(19) United States
(12) Patent Application Publication
(10) Pub. No.: US 2014/0104999 A1
(43) Pub. Date: Apr. 17, 2014

(54) COMMUNICATION APPARATUS AND DATA TRANSMISSION METHOD THEREOF

(71) Applicant: Electronics and Telecommunications Research Institute, Daejeon (KR)

(72) Inventors: Jung Hyun KIM, Daejeon (KR); Jihyung KIM, Daejeon (KR); Hyun-jae KIM, Incheon (KR); Kwang Jae LIM, Daejeon (KR); DongSeung KWON, Daejeon (KR)

(73) Assignee: Electronics and Telecommunications Research Institute, Daejeon (KR)

(21) Appl. No.: 14/052,028

(22) Filed: Oct. 11, 2013

(30) Foreign Application Priority Data
Oct. 11, 2012 (KR) 10-2012-0113155

(51) Int. Cl. H04L 1/18

(52) U.S. Cl. CPC H04L 1/1887; H04L 1/1816
USPC 370/216

(57) ABSTRACT

A communication apparatus and a data transmission method of the communication apparatus are disclosed. The communication apparatus receives feedback messages corresponding to failed data from receivers, generates a feedback matrix in response to the feedback messages, selects transmission candidate data from the feedback matrix, performs network coding on the transmission candidate data, and transmits retransmission data generated by the network coding to the receivers. Transmission candidate data is selected from the feedback matrix, and network coding is performed on the transmission candidate data to retransmit data to the receivers.

### CROSS-REFERENCE TO RELATED APPLICATION

This application claims priority to and the benefit of Korean Patent Application No. 10-2012-0113155 filed in the Korean Intellectual Property Office on Oct. 11, 2012, the entire contents of which are incorporated herein by reference.

### BACKGROUND OF THE INVENTION

(a) Field of the Invention

The present invention relates to a communication apparatus and a data transmission method thereof.

(b) Description of the Related Art

A communication apparatus is an apparatus for communicating data between different places, and can be largely divided into a source node for transmitting data and a destination node for receiving data.

When a source node transmits data to multiple destination nodes, the data may not be transmitted to the destination nodes due to a data error or the like. Hereupon, the multiple destination nodes send the source node feedback messages requesting retransmission of failed data or feedback messages requesting transmission of desired data. Based on the feedback messages, the source node may generate transmission data and transmit it to the destination nodes by using a network coding technique.

When the source node generates transmission data by using a network coding technique, the network coding technique is required to improve the reliability and efficiency of data transmission. Moreover, the network coding technique needs to be appropriate for systems with limited communication resources. However, the existing network coding techniques do not offer enough gain because of their complicated algorithm.

### SUMMARY OF THE INVENTION

The present invention has been made in an effort to provide a communication apparatus using a network coding technique that ensures a high transmission rate and high reliability and has low complexity, and a data transmission method thereof.

An exemplary embodiment of the present invention provides a data transmission method of a communication apparatus. The data transmission method of the communication apparatus may include: receiving feedback messages corresponding to failed data from receivers; generating a feedback matrix in response to the feedback messages; selecting transmission candidate data from the feedback matrix; performing network coding on the transmission candidate data; and transmitting retransmission data generated by the network coding to the receivers.

The selecting of transmission candidate data may include: if the receivers have a degree greater than a maximum number of data units that the communication apparatus can transmit, selecting data from the lowest of data indices of degree 1 of the receivers to the data index immediately preceding the lowest of the data indices of degree (maximum number of data units+1) of the receivers.

Data received successfully by all the receivers and data already transmitted a maximum number of times per data may be excluded from the feedback matrix.

The data transmission method of the communication apparatus may further include realigning the feedback matrix according to a priority order.

The realigning may include: if the priority order is defined for data, realigning column vectors of the feedback matrix; and if the priority order is defined for receivers, realigning row vectors of the feedback matrix.

The performing of network coding may include: if the first receiver requesting first data among the transmission candidate data does not request second data, and the second receiver requesting the second data does not request the first data, combining the first data and the second data by an XOR operation.

The transmitting of retransmission data to the receivers may include: dividing the retransmission data into transmission units; and attaching a header containing data information to each transmission unit and transmitting the transmission units to the receivers.

The header may include the total number of data units, the degree of each data unit, and the index of each data unit.

The data transmission method of the communication apparatus may further include, if the receivers have a degree less than the maximum number of data units that the communication apparatus can transmit, adding new data in an amount equal to the difference between the maximum number of data units and the maximum degree of the receivers.

Another exemplary embodiment of the present invention provides a communication apparatus. The communication apparatus may include: an RF module; and a processor connected with the RF module, wherein, upon receiving feedback messages corresponding to failed data from a plurality of receivers, the processor may generate a feedback matrix in response to the feedback messages, generate retransmission data by performing network coding on transmission candidate data of the feedback matrix, and transmit the retransmission data to the plurality of receivers.

In the network coding, if the first receiver requesting first data among the transmission candidate data does not request second data, and the second receiver requesting the second data does not request the first data, the first data and the second data may be combined by an XOR operation.

If the plurality of receivers have a degree greater than a maximum number of data units that the communication apparatus can transmit, data from the lowest of the data indices of degree 1 of the plurality of receivers to the data index immediately preceding the lowest of the data indices of degree (maximum number of data units+1) of the plurality of receivers may be selected as the transmission candidate data of the feedback matrix.

If the priority order is defined for data, column vectors of the feedback matrix may be realigned, and if the priority order is defined for receivers, row vectors of the feedback matrix may be realigned.

In accordance with an exemplary embodiment of the present invention, it is possible to ensure reliability and increase transmission efficiency by using a network coding technique applicable to systems with limited transmission resources.

Also, higher efficiency can be achieved by using an algorithm with low complexity when generating retransmission data based on network coding.

### BRIEF DESCRIPTION OF THE DRAWINGS

FIG. 1 is a view showing a communication system in accordance with an exemplary embodiment of the present invention.

FIG. 2A, FIG. 2B, and FIG. 2C are views showing a method of data transmission between a source node and destination nodes in a communication system in accordance with an exemplary embodiment of the present invention.

FIG. 3 is a view showing a method for a source node to generate retransmission data and transmit it to destination nodes in accordance with an exemplary embodiment of the present invention.

FIG. 4 is a view showing a feedback matrix generated by a source node.

FIG. 5 is a view showing an example of a feedback matrix.

FIG. 6 is a view showing an example of a realigned feedback matrix.

FIG. 7 is a view showing an algorithm used for network coding in accordance with an exemplary embodiment of the present invention.

FIG. 8 is a view showing the internal configuration of a destination node in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term “communication apparatus” may designate a terminal, a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and so on, or may include all or some functions of the terminal, the MT, the MS, the AMS, the HR-MS, the SS, the PSS, the AT, the UE.

Further, the term “communication apparatus” may designate a base station (BS), an advanced base station (ABS), a high reliability base station (HR-BS), a node B, an evolved node B (eNodeB), an access point (AP), a radio access station (RAS), a base transceiver station (BTS), a mobile multihop relay (MMR-BS), a relay station (RS) serving as a base station, and a high reliability relay station (HR-RS) serving as a base station, and may include all or some functions of the BS, the ABS, the nodeB, the eNodeB, the AP, the RAS, the BTS, the MMR-BS, the RS, and the HR-RS.

For convenience of description, the term “node” is used hereinafter to denote a communication apparatus; however, it should be noted that the scope of the invention is not limited by the use of this term.

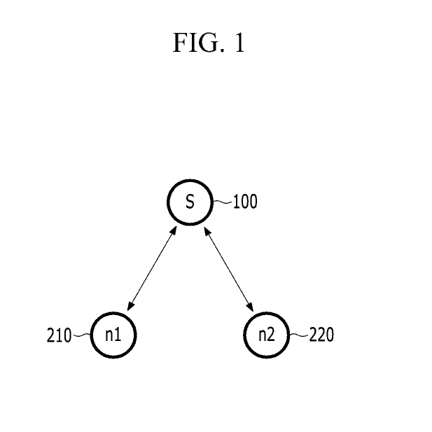

FIG. 1 is a view showing a communication system in accordance with an exemplary embodiment of the present invention.

As shown in FIG. 1, a communication system in accordance with an exemplary embodiment of the present invention includes a source node (S) 100 and multiple destination nodes (n1 and n2) 210 and 220. The source node (S) 100 is a communication apparatus that wants to transmit data, and the multiple destination nodes (n1 and n2) 210 and 220 are communication apparatuses that receive data from the source node (S) 100. Although FIG. 1 shows only two destination nodes, the source node (S) 100 may transmit data to more destination nodes.

In the communication system shown in FIG. 1, the data transmitted from the source node (S) 100 may not reach the multiple destination nodes (n1 and n2) 210 and 220 due to a transmission error or the like. Having failed to receive data, the multiple destination nodes (n1 and n2) 210 and 220 transmit feedback messages for data retransmission to the source node (S) 100. Based on the received feedback messages, the source node (S) 100 generates retransmission data and transmit it to the multiple destination nodes (n1 and n2) 210 and 220.

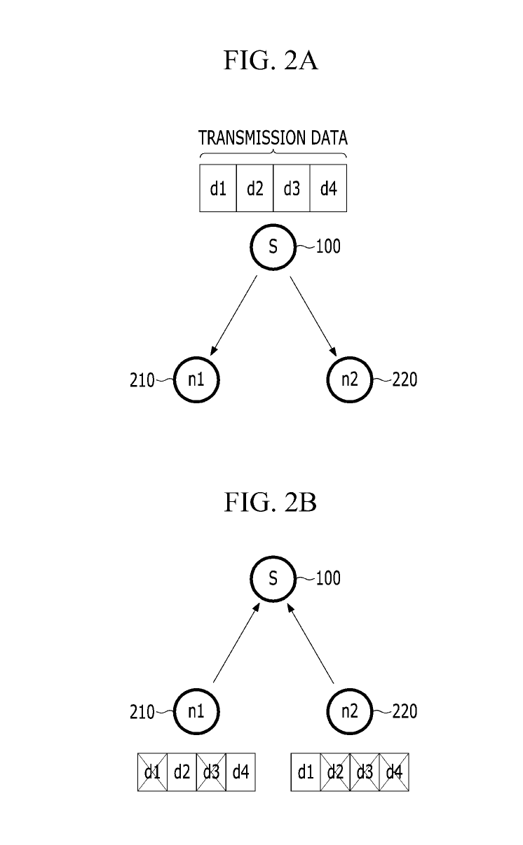

A method for the source node to retransmit failed data will be described with reference to FIG. 2A, FIG. 2B, and FIG. 2C.

FIG. 2A, FIG. 2B, and FIG. 2C are views showing a method of data transmission between a source node and destination nodes in a communication system in accordance with an exemplary embodiment of the present invention.

As shown in FIG. 2A, the source node (S) 100 transmits data d1 to d4 to the multiple destination nodes (n1 and n2) 210 and 220. The data d1 to d4 may not reach the destination nodes due to a data error or the like. In FIG. 2B, data failed to be transmitted to each destination node is indicated by X. The data d1 and d3 are data that have failed to be received by the first destination node (n1), and the data d2, d3, and d4 are data that have failed to be received by the second destination node (n2).

As shown in FIG. 2B, each of the multiple destination nodes (n1 and n2) 210 and 220 transmits a feedback message to the source node (S) 100 to inform about failed data. As is used herein, the feedback message is a message indicating information on data failed to be received by each destination node.

Next, as shown in FIG. 2C, the source node (S) 100 generates retransmission data and transmits it to the multiple destination nodes (n1 and n2) 210 and 220, based on the received feedback messages. Hereupon, the source node (S) 100 generates retransmission data by using a network coding technique. In FIG. 2C, the retransmission data generated using the network coding technique is d1⊕d2, d3, d1⊕d4, where ⊕ is an XOR operator.

Meanwhile, in accordance with an exemplary embodiment of the present invention, the source node (S) 100 generates retransmission data by a network coding technique using an algorithm with low complexity. This will be described below in detail.

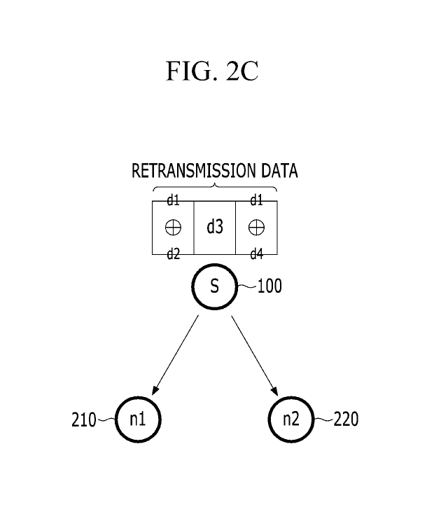

FIG. 3 is a view showing a method for a source node to generate retransmission data and transmit it to destination nodes in accordance with an exemplary embodiment of the present invention.

First, the source node (S) 100 receives feedback messages from the multiple destination nodes (n1 and n2) 210 and 220, and then updates a feedback matrix (S310 and S320).

Next, the source node (S) 100 realigns the feedback matrix according to priority order (S330).

If transmission candidate data is bigger than transmittable resource, the source node (S) 100 selects the part to be used for transmission from the feedback matrix (S340).

The source node (S) 100 generates retransmission data from the selected part of the feedback matrix by using a network coding technique (S350).

On the other hand, if the generated retransmission data is smaller than the transmittable resource, the source node (S) 100 adds new data for transmission (S360).

Next, the source node (S) 100 divides total retransmission data into transmission units (S370), and attaches a header containing data information to each transmission unit and sequentially transmits the transmission units (S380).

The steps S310 to S380 of FIG. 3 will be discussed below in more detail.

First, the step S320 of updating a feedback matrix when the source node (S) 100 receives feedback messages from the multiple destination nodes (n1 and n2) 210 and 220 will be discussed.

For the first session in which the source node (S) 100 transmits to the multiple destination nodes (n1 and n2) 210 and 220 for the first time, the feedback matrix consists of messages transmitted from the source node (S) 100 to the multiple destination nodes (n1 and n2) 210 and 220. For the subsequent sessions, the source node (S) 100 updates the feedback matrix upon receipt of feedback messages, i.e., information about data failed to be received by the multiple destination nodes (n1 and n2) 210 and 220. Data received successfully by all the destination nodes (n1 and n2) 210 and 220 and data already transmitted a maximum number of times per data are excluded from the feedback matrix.

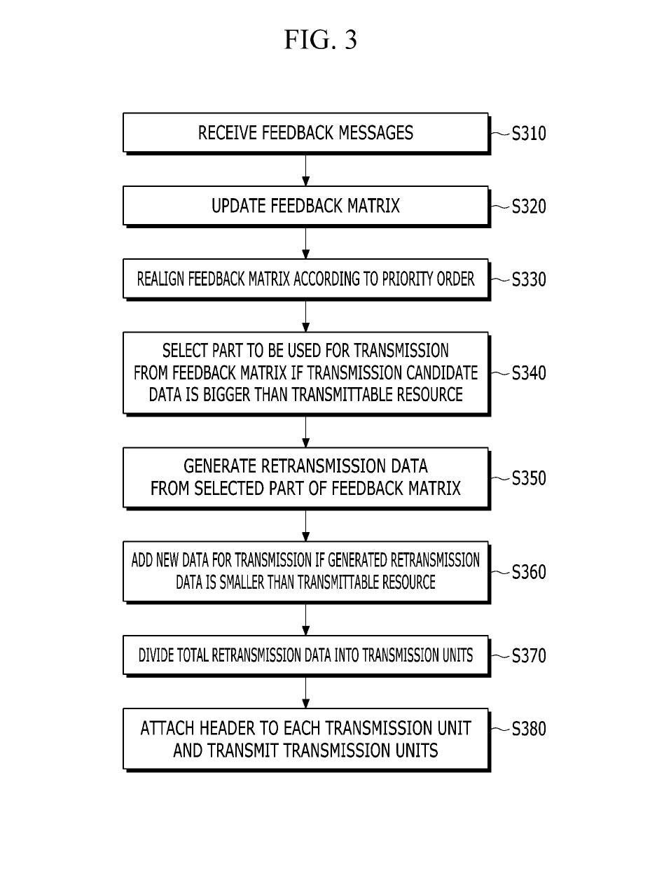

FIG. 4 is a view showing a feedback matrix generated by a source node (S) 100. In FIG. 4, nᵢ is the index of the i-th destination node, and dⱼ is the index of the j-th transmission request data. If the destination node nᵢ has requested data dⱼ, F(nᵢ,dⱼ)=1. If the destination node nᵢ has not requested the data dⱼ or has already transmitted it a maximum number of times, F(nᵢ,dⱼ)=0.

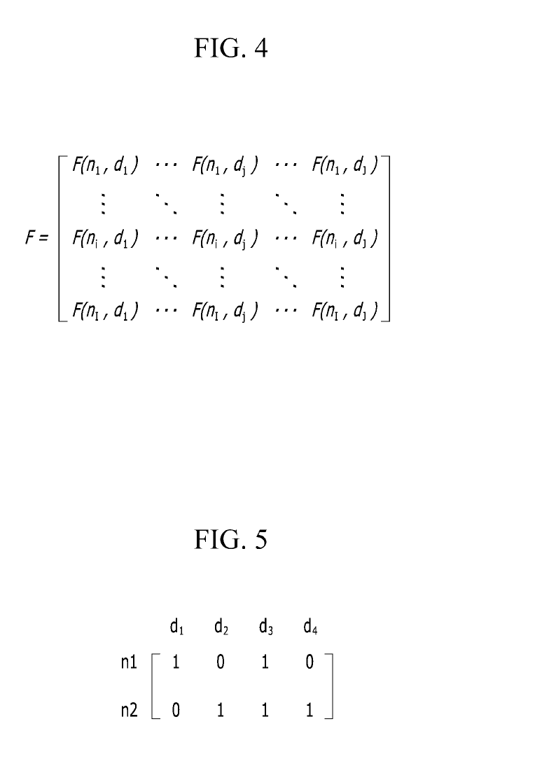

As shown in FIG. 2A, FIG. 2B, and FIG. 2C, if the first destination node (n1) has failed to receive data d1 and d3, and the second destination node (n2) has failed to receive data d2, d3, and d4, the feedback matrix becomes as shown in FIG. 5.

Next, in the step S330, the source node (S) 100 realigns the feedback matrix according to a priority order. If the priority order is defined for data, the source node (S) 100 realigns the column vectors of the feedback matrix. If the priority order is defined for destination nodes, the source node (S) 100 realigns the row vectors of the feedback matrix. Otherwise, if the priority order is defined for both data and destination nodes, the source node may realign the column vectors first and then the row vectors, or vice versa.

A method for the source node to select the part (transmission candidate data) to be used for actual transmission from the feedback matrix in the step S340 will be discussed in detail. The maximum number of data units that can be transmitted until the next update of the feedback matrix is defined as L, and the number of 1's in a row vector of the feedback matrix is defined as a node degree. If every destination node has a degree no greater than L, the step S340 is omitted. Otherwise, data from the lowest of the data indices of degree 1 of the destination nodes to the data index immediately preceding the lowest of the data indices of degree (L+1) of the destination nodes are selected.

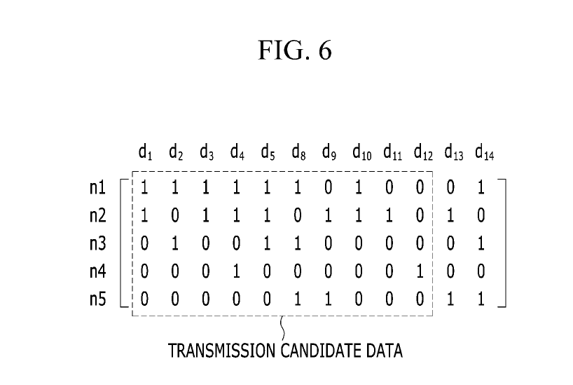

The step S340 will be described with respect to an example of a realigned feedback matrix shown in FIG. 6.

In the realigned feedback matrix of FIG. 6, the node degree (number of 1's in the column vector) of the first destination node n1 is 8, the node degree of the second destination node n2 is 8, the node degree of the third destination node n3 is 4, the node degree of the fourth destination node n4 is 2, and the node degree of the fifth destination node n5 is 4. If the maximum number L of data units that can be transmitted for each retransmission from the source node is 7, not every node has a degree less than or equal to 7. Thus, the part to be used for actual transmission is selected. The data indices at which each destination node has a node degree of 1 are d1, d1, d2, d4, and d8. Among them, the lowest data index d1 serves as the starting point. The data indexes at which each destination node has a node degree of 8 (L+1=7+1) are d14, d13, d14, none, and none. Thus, the data index d12 immediately preceding the lowest data index d13 serves as the ending point. Accordingly, d1 to d12 in the realigned feedback matrix of FIG. 6 become transmission candidate data, and this transmission candidate data is used to generate retransmission data.

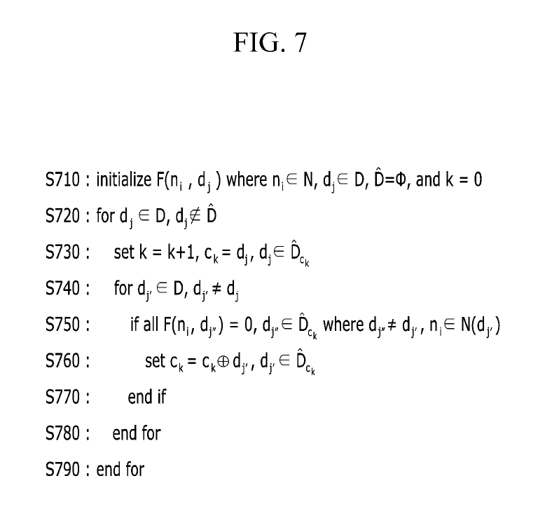

In the step S350, the source node performs network coding on the selected part (transmission candidate data) of the feedback matrix by the algorithm of FIG. 7, thereby generating retransmission data. Two or more transmission candidate data blocks combined as one data set by network coding is called “combined data”.

FIG. 7 is a view showing an algorithm used for network coding in accordance with an exemplary embodiment of the present invention. In FIG. 7, N is a set of destination nodes, D is a set of transmission candidate data, N(dⱼ) is a set of destination nodes requesting data dⱼ, cₖ is k-th combined data, \hat{D}_{c}_{ₖ} is a transmission data set constituting the combination data cₖ, and \hat{D} is a union of all transmission data sets \hat{D}_{c}_{ₖ}.

A method of generating retransmission data from the feedback matrix of FIG. 5 by using the algorithm of FIG. 7 will be discussed.

First, the step S710 is performed to initialize the feedback matrix, as shown in FIG. 5. In the step S720, \hat{D} is an empty set. Thus, the step S730 is applied to d1, whereby c1=d1 and d1 is included in \hat{D}_{c1}. Next, the step S750 is applied to d2 according to the step S740. Once the step S750 is performed on d2, n2 requesting d2 has not requested d1 included in \hat{D}_{c1}, and therefore the step S760 is performed. According to the step S760, c1=c1⊕d2=d1⊕d2, and d2 is included in \hat{D}_{c1}. Since only n2 has requested d2, the step S740 is applied.

Next, the step S750 is applied to d3 according to the step S740. The step S740 is applied again because n1 requesting d3 has requested d1. The step S750 is applied to d4 according to the step S740. Once the step S750 is performed on d4, n2 requesting d4 has requested d2 included in \hat{D}_{c1}, and therefore the step S760 is not performed. Since there is no more data to check, the next step S720 is performed.

d3, which is not an element of \hat{D}, is selected in the step S720, and c2=d3 in the step S740. d3 is included in \hat{D}_{c2}. Next, the step S750 is applied to d1 according to the step S740. According to the step S750, n1 requesting d1 has requested d3 included in \hat{D}_{c2}, and therefore the routine goes back to the step S740. The step S750 is applied to d2 according to the step S740. Accordingly, because n2 requesting d2 has requested d3 included in \hat{D}_{c2}, the algorithm goes back to the step S740. Next, the step S750 is applied to d4. Accordingly, the step S720 is performed again since there is no more data to check after n2 requesting d4 has requested d3 included in \hat{D}_{c1}.

D4, which is not an element of \hat{D}, is selected in the step S720, and c3=d4 in the step S740. D4 is included in \hat{D}_{c3}. Next, the step S750 is applied to d1 according to the step S740. According to the step S750, n1 requesting d1 has not requested d4 included in \hat{D}_{c3}, and therefore the step S760 is performed. Accordingly, c3=c3⊕d1=d4⊕d1, and d1 is included in \hat{D}_{c3}. Since only n1 has requested d1, the step S740 is performed according to the step S770. Next, the step S740 is applied to d2. According to the step S750, n2 requesting d2 has requested d3 included in \hat{D}_{c3}, and therefore the step S740 is performed again. Next, the step S750 is applied to d3. Accordingly, the step S720 is performed again since there is no more data to check after n2 requesting d3 has requested d4 included in \hat{D}_{c3}. Hereupon, the step S720 is performed on all the data to finish the algorithm.

Accordingly, when the algorithm shown in FIG. 7 is applied to the feedback matrix of FIG. 5, d1⊕d2, d3, and d1⊕d4 are generated as retransmission data, as shown in FIG. 2c. To sum up the algorithm of FIG. 7, if n1 requesting d1 has not requested d2, and n2 requesting d2 has not requested d1, d1 and d2 become combination data (d1⊕d2). Also, if n1 requesting d1 has not requested d4, and n2 requesting d4 has not requested d1, d1 and d4 become combination data (d1⊕d4).

Next, the step S360 of FIG. 3 will be described in more detail. If the maximum node degree for each destination node is less than the maximum number L of transmittable data units, new data is added in an amount equal to the difference between L and the maximum node degree. If there is no more data to be sent, transmission candidate data or combination data may be repeatedly added, or new combination data may be generated and added.

The step S370 of FIG. 3 will be described in more detail. Total retransmission data generated for transmission until the next update of the feedback matrix is divided into maximum transmission units. The maximum transmission units may be determined in advance depending on the resource allocation method, or may vary for each transmission.

Lastly, in the step S380 of FIG. 3, a header containing information on data is added to each of the maximum transmission units. The total number of data units, the degree of each data unit, and the index of each data unit are included in the header. The degree of combination data is 2 or more, and the degree of data other than combination data is 1. The source node transmits the total number of data transmission units to the destination nodes.

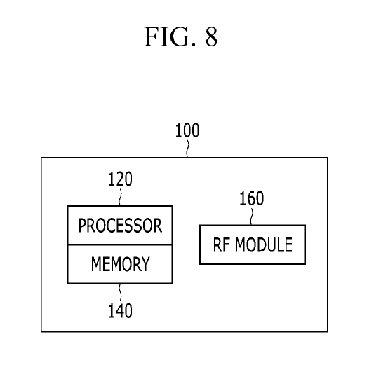

FIG. 8 is a view showing the internal configuration of a destination node (S) 100 in accordance with an exemplary embodiment of the present invention.

Referring to FIG. 8, the destination node (S) 100 includes a processor 120, a memory 140, and a radio frequency (RF) module 160. The processor 120 may be configured to implement the above-explained procedures and methods. The memory 140 is connected with the processor 120, and stores various kinds of information related to the operation of the processor 120. The RF module 160 is connected with the processor 120, and transmits or receives a radio signal. The destination node (S) 100 may have a single antenna or multiple antennas.

In accordance with an exemplary embodiment of the present invention, it is possible to ensure reliability and increase transmission efficiency by using a network coding technique applicable to systems with limited transmission resources. Also, higher efficiency can be achieved by using an algorithm with low complexity when generating retransmission data based on network coding.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A data transmission method of a communication apparatus, the method comprising:
receiving a feedback message corresponding to failed data from receivers;
generating a feedback matrix in response to the feedback message;
selecting transmission candidate data from the feedback matrix;
performing network coding on the transmission candidate data; and
transmitting retransmission data generated by the network coding to the receivers.

2. The method of claim 1, wherein the selecting of transmission candidate data comprises: if the receivers have a degree greater than a maximum number of data units that the communication apparatus can transmit, selecting data from the lowest of data indices of degree 1 of the receivers to the data index immediately preceding the lowest of the data indices of degree (maximum number of data units+1) of the receivers.

3. The method of claim 1, wherein data received successfully by all the receivers and data already transmitted a maximum number of times per data are excluded from the feedback matrix.

4. The method of claim 1, further comprising realigning the feedback matrix according to a priority order.

5. The method of claim 4, wherein
the realigning comprises:
if the priority order is defined for data, realigning column vectors of the feedback matrix; and
if the priority order is defined for receivers, realigning row vectors of the feedback matrix.

6. The method of claim 1, wherein
in the network coding,
if the first receiver requesting first data among the transmission candidate data, does not request second data, and the second receiver requesting the second data does not request the first data, the first data and the second data are combined by an XOR operation.

7. The method of claim 1, wherein
the transmitting of retransmission data to the receivers comprises:
dividing the retransmission data into transmission units; and
attaching a header containing data information to each transmission unit and transmitting the transmission units to the receivers.

8. The method of claim 7, wherein the header comprises the total number of data units, the degree of each data unit, and the index of each data unit.

9. The method of claim 1, further comprising, if the receivers have a degree less than the maximum number of data units that the communication apparatus can transmit, adding new data in an amount equal to the difference between the maximum number of data units and the maximum degree of the receivers.

10. A communication apparatus comprising:
an RF module; and
a processor connected with the RF module,
wherein, upon receiving feedback messages corresponding to failed data from a plurality of receivers, the processor generates a feedback matrix in response to the feedback messages, generates retransmission data by performing network coding on transmission candidate data of the feedback matrix, and transmits the retransmission data to the plurality of receivers.

11. The communication apparatus of claim 10, wherein, in the network coding, if the first receiver requesting first data among the transmission candidate data does not request second data, and the second receiver requesting the second data does not request the first data, the first data and the second data are combined by an XOR operation.

12. The communication apparatus of claim 10, wherein, if the plurality of receivers have a degree greater than a maximum number of data units that the communication apparatus can transmit, data from the lowest of the data indices of degree 1 of the plurality of receivers to the data index immediately preceding the lowest of the data indices of degree (maximum number of data units+1) of the plurality of receivers is selected as the transmission candidate data of the feedback matrix.

13. The communication apparatus of claim 10, wherein, if the priority order is defined for data, column vectors of the feedback matrix are realigned, and if the priority order is defined for receivers, row vectors of the feedback matrix are realigned.
